(19) United States
(12) Patent Application Publication
(10) Pub. No.: US 2006/0178267 A1
(43) Pub. Date: Aug. 10, 2006

(54) Receiving container, method for manufacturing the receiving container, backlight assembly having the receiving container and display device having the back light assembly

(76) Inventors: Jin-Gwan Kim, Asan-si (KR); Tae-Seok Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/348,703

(22) Filed: Feb. 7, 2006

(30) Foreign Application Priority Data
Feb. 7, 2005 (KR) 2005-11261

(51) Int. Cl. B41M 5/24

(52) U.S. Cl. 503/227

(57) ABSTRACT

In a receiving container, a method for manufacturing the receiving container, a backlight assembly having the receiving container and a display device having the backlight assembly, the receiving container includes sidewalls, a first protrusion and second protrusions. The sidewalls are connected with each other. The first protrusion inwardly extends from inner side faces of the sidewalls. A display panel is positioned on the first protrusion. Second protrusions upwardly extend from at least one of the sidewalls. The display panel is fixed by the second protrusions. The second protrusion has a burr-receiving portion receiving a burr due to a residual of a melted resin.

This application claims priority to Korean Patent Application No. 2005-11261 filed on Feb. 7, 2005, and all the benefits accruing therefrom under 35 U.S.C. §119, the contents of which are herein incorporated by reference in its entirety.

### BACKGROUND OF THE INVENTION

1. Field of the Invention

The present invention relates to a receiving container, a method for manufacturing the receiving container, a backlight assembly having the receiving container and a display device having the backlight assembly. More particularly, the present invention relates to a receiving container capable of suppressing the generation of a defect due to a residual of a melted resin, a method for manufacturing the receiving container, a backlight assembly having the receiving container and a display device having the receiving container.

2. Description of the Related Art

In general, a display device includes a display part for displaying data as images. A flat panel display device is a kind of the display device. The flat panel display device is relatively small in size and light in weight. In addition, the flat panel display device has a relatively high resolution. Thus, the flat panel display device has been widely used.

A liquid crystal display device is a kind of the flat panel display device. The liquid crystal display device has been most widely used as the display device. The liquid crystal display device includes a liquid crystal layer having liquid crystal molecules. When a magnetic field is applied to the liquid crystal layer, the liquid molecules may rearrange to vary a light transmittance of the liquid crystal layer. Thus, the crystal display device may display the images.

The liquid crystal display device includes a backlight assembly and a display unit. The backlight assembly generates a light. The display unit displays images by using the light supplied from the backlight assembly.

The display unit includes a liquid crystal display panel and a drive circuit board. The liquid crystal panel displays the image. The drive circuit board supplies a drive signal for operating the liquid crystal display panel.

The liquid crystal display panel includes a thin film transistor (TFT) substrate, a color filter substrate and the liquid crystal layer. The TFT substrate faces the color filter substrate. The TFT substrate is combined with the color filter substrate. The liquid crystal layer is positioned between the TFT substrate and the color filter substrate.

The TFT substrate is a transparent glass substrate having TFTs that are arranged in a matrix shape. The TFT is a kind of a switch device. A source terminal of the TFT is connected with a data line. A gate terminal of the TFT is connected with a gate line. A drain terminal of the TFT is connected with a pixel electrode including a transparent conductive material.

The color filter substrate faces the TFT substrate. In addition, the color filter substrate is apart from the TFT substrate. A plurality of red pixels, a plurality of green pixels and a plurality of blue pixels are formed in the color filter substrate by a thin film process. A common electrode is formed on the color filter substrate. The common electrode includes a transparent conductive material.

Power is applied to the gate terminal of the TFT so that the liquid crystal display panel may be turned on. In case that the liquid crystal display panel is turned on, a magnetic field is generated between the pixel electrode and the common electrode. The magnetic field may enable the liquid crystal molecules included in the liquid crystal layer positioned between the TFT substrate and the color filter substrate to be rearranged. Thus, a light transmittance of the liquid crystal layer may vary. As a result, the liquid crystal display panel may display images having a desired gradation by using a light supplied from the backlight assembly.

The drive circuit board includes a source drive circuit board and a gate drive circuit board. In case that a gate drive circuit is formed on the TFT substrate, the liquid crystal display panel may operate without the gate drive circuit board. A source flexible circuit film connects the source drive circuit board to one end portion of the TFT substrate. In case that the liquid crystal display panel operates without the gate drive circuit board, the source drive circuit board may generate a source drive signal and a gate drive signal for operating the liquid crystal display panel. The source drive signal may be used for controlling the data line formed on the TFT substrate. The source drive signal is applied to the data line through the source flexible circuit film. The gate drive signal may be used for controlling the gate line formed on the TFT substrate. The gate drive signal is applied to the gate line through the source flexible circuit film and the gate flexible circuit film. A conductive wire is formed on the TFT substrate so that the source flexible circuit film and the gate flexible circuit film may be electrically connected to each other.

The display unit is received in a first receiving container in which the backlight assembly is also received. In detail, the display unit is received in a second receiving container. The source flexible circuit film is bent so that the source drive circuit board backlight assembly may be fixed beneath a rear face of the first receiving container. Here, the source flexible circuit may make close contact with a side portion of the second container. Thus, the display unit may be positioned over the backlight assembly.

The second receiving container is generally formed by an injection molding process. A melted resin may be supplied from a pinpoint gate to a space defined by a metal mold to form the second receiving container. In detail, the pinpoint gate corresponds to the side face of the second container, and the side face makes close contact with the source flexible circuit film. A burr due to a residual of the melted resin is formed at the side face of the second container, and the side face corresponds to the pinpoint gate. Thus, the burr is generally removed by additional processes. However, because the additional processes are needed to remove the burr, a cost required for manufacturing the display device is increased.

In addition, the burr due to the residual of the melted resin damages the source flexible circuit film. Thus, displaying image of the display device is deteriorated.

To overcome the above-mentioned problem, a metal mold for the injection molding process, the metal mold having pinpoint gates corresponding to ribs between which a liquid crystal display panel is positioned, has been developed. The ribs enable the receiving container to efficiently support the liquid crystal display panel. The pinpoint gate has a relatively small diameter.

However, the pinpoint gate having the relatively small diameter does not have high resistance against a relatively high temperature of the melted resin and a relatively high pressure due to the relatively small diameter. Thus, the life span of the metal mold having the pinpoint gate may be substantially short. As a result, the metal mold frequently needs to be replaced by new ones so that a cost required for manufacturing the metal mold is increased.

### SUMMARY OF THE INVENTION

An exemplary embodiment provides a receiving container efficiently manufactured without additional processes.

Another exemplary embodiment provides a method for manufacturing the above receiving container.

Another exemplary embodiment provides a backlight assembly having above the receiving container.

Another exemplary embodiment provides a display device having the above backlight assembly.

In an exemplary embodiment, a receiving container includes sidewalls, a first protrusion and a plurality of second protrusions. The sidewalls are connected with each other. The first protrusion inwardly extends from inner side faces of the sidewalls. A display panel is positioned on the first protrusion. The second protrusions upwardly extend from at least one of the sidewalls. The display panel positioned on the first protrusion is fixed by the second protrusions. The second protrusion has a burr-receiving portion receiving a burr due to a residual of a melted resin.

In another exemplary embodiment, a method for manufacturing a receiving container is provided as follows. A shape of the receiving container is designed. The receiving container includes sidewalls, a first protrusion and a plurality of second protrusions. The sidewalls are connected with each other. The first protrusion is inwardly protruded from inner faces of the sidewalls. A display panel is positioned on the first protrusion. The second protrusions are upwardly protruded from at least one of the sidewalls. The display panel positioned on the first protrusion is fixed by the second protrusions. The second protrusion includes a burr-receiving portion in which a burr is received. An upper core including a first molding recess at a lower face portion thereof is provided. A shape of the first molding recess corresponds to a shape of an upper portion of the receiving container. The upper core includes openings passing through the upper core to be communicated with the first molding recess. The opening corresponds to the second protrusion. A lower core including a second molding recess at an upper face portion thereof is provided. A shape of the second molding recess corresponds to a shape of a lower portion of the receiving container. A bush including a height substantially larger than a height of the opening into the opening is provided. The bush includes a pinpoint gate through which a melted resin is injected. The bush is inserted into the opening. The melted resin is injected between the upper core and the lower core through the pinpoint gate.

In another exemplary embodiment, a backlight assembly includes a lamp, a first receiving container and a second receiving container. The lamp generates a light. The first receiving container receives the lamp. The second receiving container is received in the first receiving container. The second receiving container includes sidewalls, a first protrusion and a plurality of second protrusions. The sidewalls are connected to each other. The first protrusion inwardly extends from inner faces of the sidewalls. A display panel is positioned on the first protrusion. The second protrusions upwardly extend from at least one of the sidewalls. The display panel positioned on the first protrusion is fixed by the second protrusions. The second protrusion has a burr-receiving portion receiving a burr.

In another exemplary embodiment, a display device includes a backlight assembly, a plurality of optical sheets and a display unit. The backlight assembly includes a lamp, a first receiving container and a second receiving container. The lamp generates a light. The first receiving container receives the lamp. The second receiving container is received in the first receiving container. The second receiving container includes sidewalls, a first protrusion and a plurality of second protrusions. The sidewalls are connected to each other. The first protrusion inwardly extends from inner faces of the sidewalls. A display panel is positioned on the first protrusion. The second protrusions upwardly extend from at least one of the sidewalls. The display panel positioned on the first protrusion is fixed by the second protrusions. The second protrusion has a burr-receiving portion receiving a burr. The light generated from the lamp passes through the optical sheets. The display unit displays an image by using the light passing through the optical sheets.

### BRIEF DESCRIPTION OF THE DRAWINGS

The above and other advantages of the present invention will become readily apparent by reference to the following detailed description when considered in conjunction with the accompanying drawings in which:

FIG. 1 is an exploded perspective view illustrating an exemplary embodiment of a liquid crystal display device in accordance with the present invention;

FIG. 2 is a rear view illustrating the liquid crystal display device in FIG. 1;

FIG. 3 is a perspective view illustrating an exemplary embodiment of a receiving container in accordance with the present invention;

FIG. 4 is an enlarged perspective view illustrating portion A in FIG. 3;

FIG. 5 is a cross-sectional view taken along line I-I′ in FIG. 4; and

FIG. 6 is a partial cross-sectional view illustrating an exemplary embodiment of a metal mold used for an injection molding in accordance with the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element is referred to as being “on” another element, it can be directly on the other element or layer or intervening elements may be present. Like reference numerals refer to like elements throughout

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, an etched region illustrated as a rectangle will, typically, have rounded or curved features. Thus, the regions illustrated in the figures are schematic in nature and their shapes are not intended to illustrate the precise shape of a region of a device and are not intended to limit the scope of the present invention.

Various embodiments of the present invention will now be described with reference to the accompanying drawings.

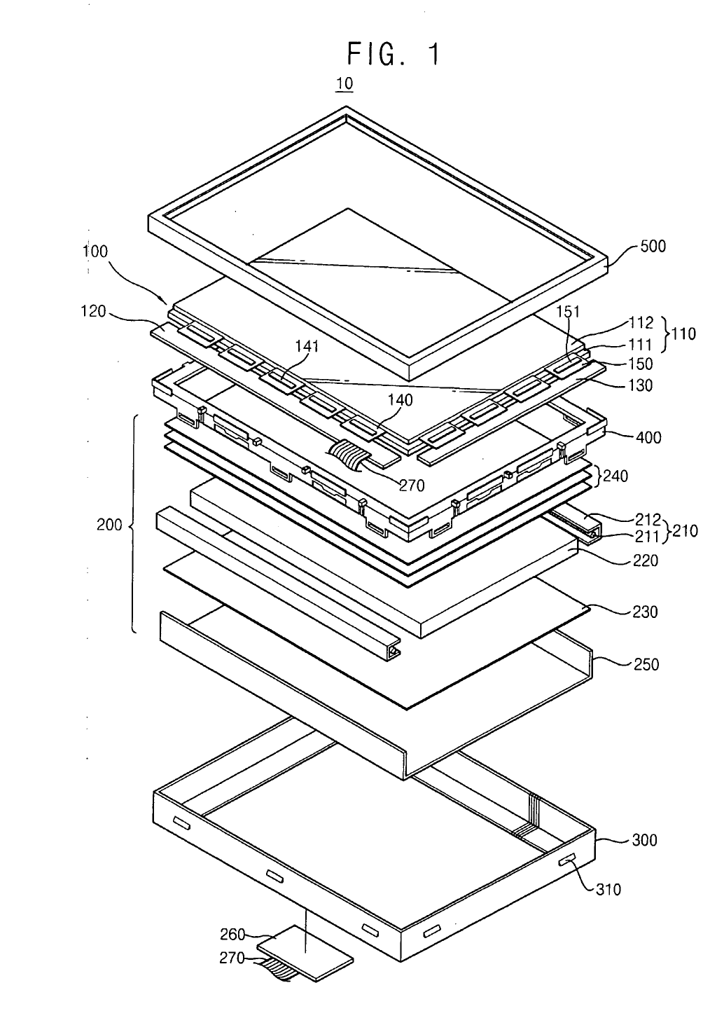

FIG. 1 is an exploded perspective view illustrating an exemplary embodiment of a liquid crystal display device in accordance with the present invention.

Referring to FIG. 1, a liquid crystal display device 10 includes a display unit 100 and a backlight assembly 200. The display unit 100 includes a liquid crystal layer. A light transmittance included in the display unit 100 varies so that the display unit 100 may display images by using an electrical image signal applied thereto. The backlight assembly 200 provides the display unit 100 with light.

In addition, the liquid crystal display device 10 includes a first receiving container 300, a second receiving container 400 and a top chassis 500. The first receiving container 300 receives the backlight assembly 200. The second receiving container 400 receives the display unit 100.

The display unit 100 includes a liquid crystal display panel 110, a source drive circuit board 120 and a gate drive circuit board 130.

The liquid crystal display panel 110 includes a thin film transistor (TFT) substrate 111, a color filter substrate 112 and a liquid crystal layer (not shown). The color filter substrate 112 faces the TFT substrate 111. The color filter substrate 112 is combined with the TFT substrate 111. The liquid crystal layer is positioned between the TFT substrate 111 and the color filter substrate 112.

In exemplary embodiments, the TFT substrate 111 may be a transparent glass substrate having thin film transistors (not shown) that are arranged in a matrix shape. The TFT is a kind of a switch device. The TFT has a source terminal (not shown), a gate terminal (not shown) and a drain terminal (not shown). The source terminal and the drain terminal are connected to a data line (not shown) and a gate line (not shown), respectively. A pixel electrode (not shown) is formed on the drain terminal. The pixel electrode may include, but is not limited to, a transparent conductive material such as indium tin oxide (ITO).

The color filter substrate 112 is spaced apart from the TFT substrate 111. The color filter substrate 112 faces the TFT substrate 111. Color pixels (not shown) may be formed in the color filter substrate 112 by a thin film process. In exemplary embodiments, the color pixel may be a red pixel, a green pixel or a blue pixel. A red ray of a light incident on the red pixel may selectively pass through the red pixel. A green ray of a light incident on the green pixel may selectively pass through the green pixel. A blue ray of a light incident on the blue pixel may selectively pass through the blue pixel. A common electrode (not shown) that may include a transparent conductive material such as ITO may also be formed on the color filter substrate 112.

Power applied to the gate terminal of the TFT turns on the TFT. When the TFT is turned on, a magnetic field may be generated between the pixel electrode and the common electrode. The magnetic field rearranges liquid crystal molecules included in the liquid crystal layer positioned between the TFT substrate 111 and the color filter substrate 112 such that the light transmittance of the liquid crystal layer with respect to a light supplied from a lamp (not shown) may vary. Thus, the liquid crystal display panel 110 may display images having a desired gradation.

A source flexible circuit film 140 connects the source drive circuit board 120 to the liquid crystal display panel 110 such that the source drive circuit board 120 may provide the liquid crystal display panel 110 with an image signal. A gate flexible circuit film 150 connects the gate drive circuit board 130 to the liquid crystal display panel 110 such that the gate drive circuit board 130 may provide the liquid crystal display panel 110 with a scan signal. The image signal and the scan signal are required for driving the liquid crystal display panel 110.

In exemplary embodiments, the source flexible circuit film 140 may include, but is not limited to, a tape carrier package (TCP) or a chip on film (COF). The gate flexible circuit film 150 may also include, but is not limited to, a tape carrier package (TCP) or a chip on film (COF).

Referring to FIG. 1, the source flexible circuit film 140 includes a source drive chip 141. The source drive chip 141 may enable the image signal to be applied to the liquid crystal display panel 110 at a desired timing. The gate flexible circuit film 150 includes a gate drive chip 151. The gate drive chip 151 may enable the scan signal to be applied to the liquid crystal display panel 110 at a desired timing.

In exemplary embodiments where a gate drive circuit (not shown) is directly formed in the TFT substrate 111, the liquid crystal display device 10 may be operated without the gate drive circuit board 130.

The backlight assembly 200 includes a lamp unit 210, a light guide panel 220, a reflection plate 230, a plurality of optical sheets 240 and a third receiving container 250.

The lamp unit 210 includes at least one lamp 211 generating a light. In addition, the lamp unit 210 may include at least one protection cover 212. The protection cover 212 receives a lamp 211 such that the lamp 211 may be protected or minimally damaged from an external impact to the liquid crystal display device 10. Where the lamp unit 210 includes at least two lamps 211, a brightness of the light generated from the lamps 211 may be improved.

The light guide panel 220 includes a light guide pattern (not shown). The light guide pattern enables the light incident on the light guide panel 220 to be irradiated toward the liquid crystal display panel 110 by varying a path of the light therein.

The reflection plate 230 reflects a leakage light leaking from the light guide panel 220 toward the light guide panel 220. Thus, the leakage light may be reused.

The optical sheets 240 improve a brightness of the light irradiated from the light guide panel 220. The optical sheets 240 may include, but are not limited to, a polarizing sheet and/or a dispersion sheet. The dispersion sheet may disperse the light incident thereon such that the brightness of the light may be improved.

The third receiving container 250 sequentially receives the reflection plate 230, the light guide panel 220, the lamp unit 210 and the optical sheets 240. The third receiving container 250 may include, but is not limited to, a metal having a relatively high strength. In exemplary embodiments, the metal may be aluminum. The metal may efficiently transmit a heat generated from the lamp unit 210.

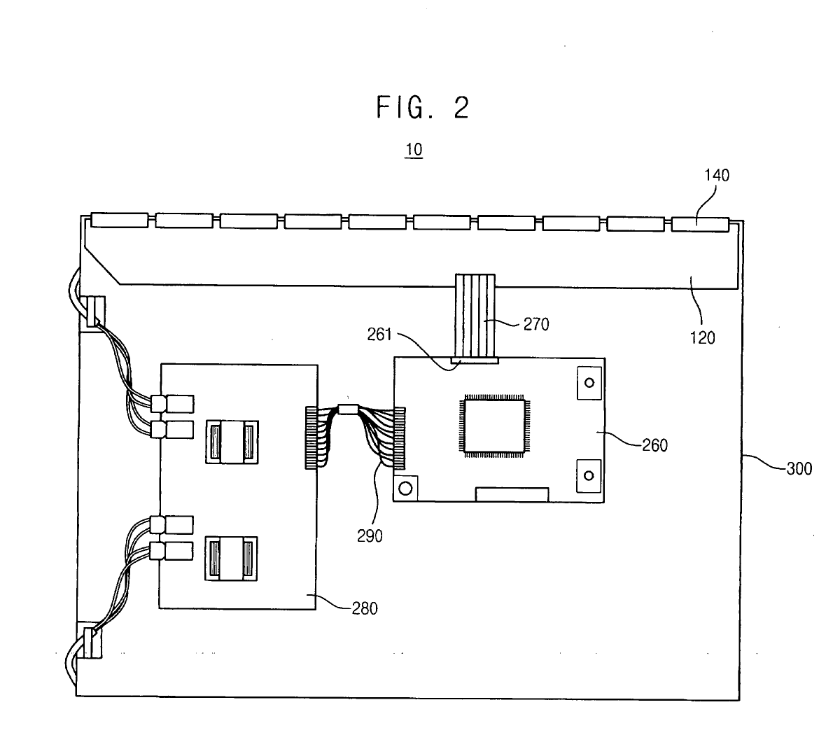

FIG. 2 is a rear view illustrating the display device in FIG. 1.

Referring to FIGS. 1 and 2, the liquid crystal display device 10 includes the first receiving container 300. The first receiving container 300 receives the display unit 100 and the backlight assembly 200.

The display unit 100 includes the liquid crystal display panel 110. The source flexible circuit film 140 connects the source drive circuit board 120 to the liquid crystal display panel 110. The source flexible circuit film 140 may be bent such that the source drive circuit board 120 may make contact with a rear face of the first receiving container 300, essentially fixing the display unit 100.

The gate flexible circuit film 150 connects the gate drive circuit board 130 to the liquid crystal display panel 110. The gate flexible circuit film 150 may be bent such that the gate drive circuit board 130 may make contact with a sidewall of the first receiving container 300 or the rear face of the first receiving container 300, essentially fixing the display unit 100.

As described above, in case that the gate drive circuit is directly formed in the TFT substrate 111, the liquid crystal display device 10 may be operated without the gate drive circuit board 130.

As illustrated in the exemplary embodiment of FIG. 2, a control printed circuit board 260, a signal transmission film 270 and an inverter 280 are also positioned on the rear face of the first receiving container 300.

The control printed circuit board 260 generates a control signal for controlling an operation of the display unit 100. The signal transmission film 270 electrically connects the source drive circuit board 120 to the control printed circuit board 260. Thus, the control signal may be transmitted from the control printed circuit board 260 to the source drive circuit board 120 through the signal transmission film 270.

In detail, a first end portion of the signal transmission film 270 is inserted into and combined with a connector 261 of the control printed circuit board 260 such that the first end may be connected with the control printed circuit board 260. A second end portion of the signal transmission film 270 is connected with the source drive circuit board 120. In exemplary embodiments, the signal transmission film 270 may be connected by a thermo compressing bonding process using an anisotropic conductive film as a connection medium.

The inverter 280 generates a power signal for operating the control printed circuit board 260. A cable 290 connects the inverter 280 to the control printed circuit board 260.

The source flexible circuit film 140 connected between the liquid crystal display panel 110 and the source drive circuit board 120 providing the liquid crystal display panel 110 with the drive signal is bent such that the source drive circuit board 120 may make contact with the rear face of the first receiving container 300, essentially fixing the display unit 100.

The gate flexible circuit film 150 connected between the liquid crystal display panel 110 and the gate drive circuit board 130 providing the liquid crystal display panel 110 with the drive signal is bent such that the gate drive circuit board 130 may make contact with the rear face of the first receiving container 300, essentially fixing the display unit 100.

In exemplary embodiments, the source and gate flexible circuit films 140 and 150 may closely contact sidewalls of the second receiving container 400. In alternative embodiments, the second receiving container 400 may be formed by an injection molding process. In an exemplary embodiment of an injection molding process, melted resin may be injected into a metal mold to form the second receiving container 400.

The metal mold may have at least one pinpoint gate through which the melted resin is introduced into the metal mold. Where the metal mold has at least two pinpoint gates, the melted resin may be more efficiently introduced into the metal mold such that a yield of the second receiving container 400 may increase. A residual of the melting resin may remain around the pinpoint gate and solidified around the pinpoint gate. The residual frequently results in a burr on the second receiving container 400.

The burr has an indeterminate shape. The burr may be formed on the second receiving container 400. The burr may cause damage to the source and gate flexible circuit films 140 and 150 making close contact with sidewalls of the second receiving container 400. In detail, signal lines included in the source and gate flexible circuit films 140 and 150 may be shorted by the burr. Damages of the source and gate flexible circuit films 140 and 150 may also deteriorate the display quality of the display device.

In addition, the second receiving container 400 may have an irregular face on which the burr is formed. Thus, it may be difficult for the second receiving container 400 having the burr to be combined with other parts of the display device.

To overcome these disadvantages including the burr, an additional process using a knife, a chisel or a nipper is performed to remove the residual resin or burr. However, with the additional process, a cost required for manufacturing the display device increases in addition to a time required for manufacturing the display device.

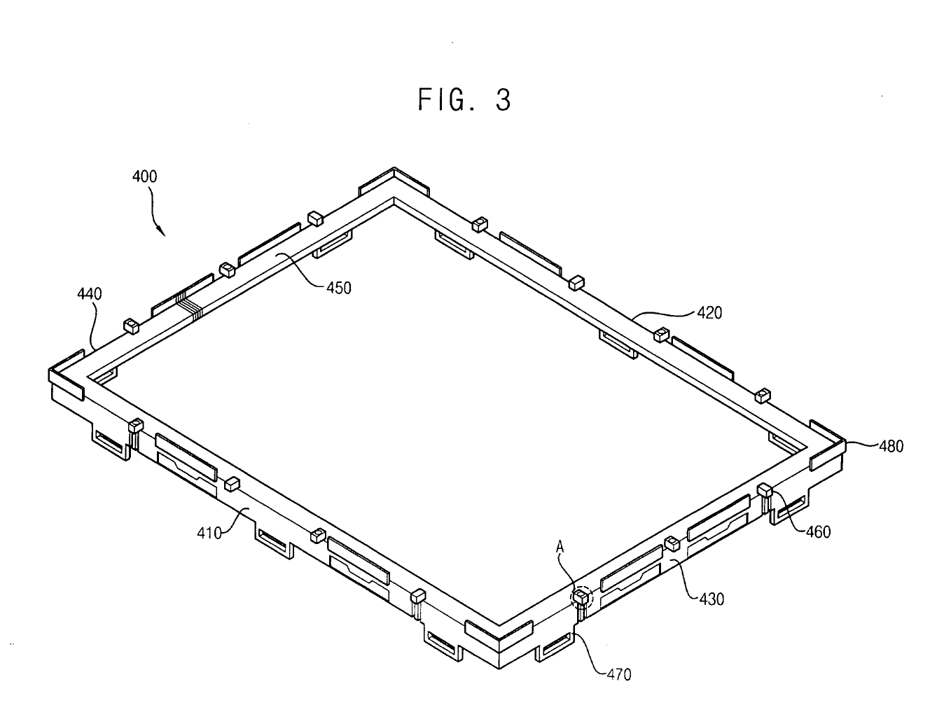

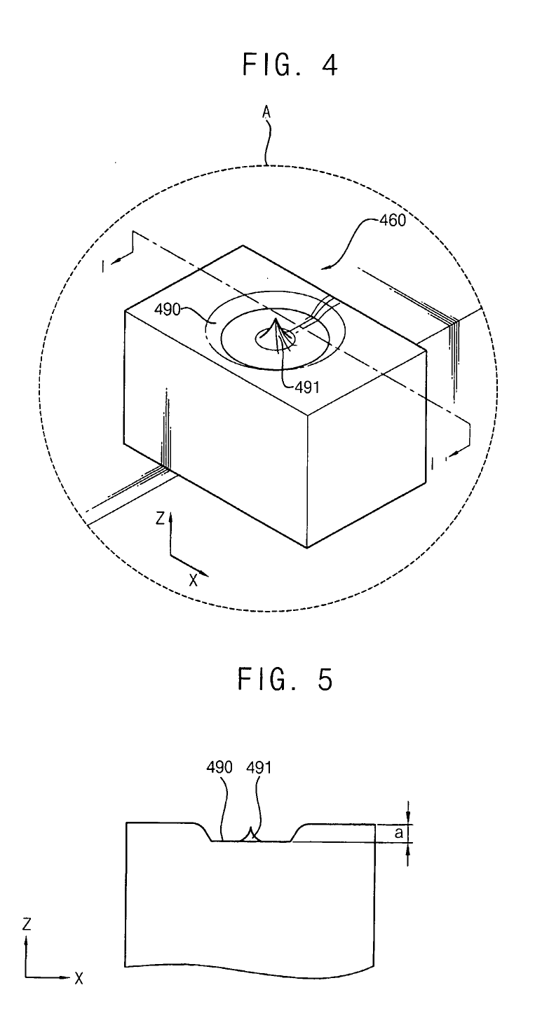

FIG. 3 is a perspective view illustrating an exemplary embodiment of the second receiving container in which the liquid crystal display device is received in accordance with the present invention. FIG. 4 is a perspective view illustrating portion A in FIG. 3. FIG. 5 is a cross-sectional view taken along line I-I′ in FIG. 4.

Referring to FIGS. 3 to 5, the second receiving container 400 includes a first sidewall 410, a second sidewall 420, a third sidewall 430 and a fourth sidewall 440. The first to fourth sidewalls 410, 420, 430 and 440 are connected with each other to define the second receiving container 400. In addition, the second receiving container 400 includes a first protrusion 450 and a plurality of second protrusions 460.

The first protrusion 450 is inwardly extended from inner side faces of the first, second, third and fourth sidewalls 410, 420, 430 and 440. The liquid crystal display panel 110 illustrated in FIG. 1 is positioned on the first protrusion 450. Essentially, the first protrusion 450 supports the liquid crystal display panel 110 illustrated in FIG. 1.

The second protrusions 460 are upwardly extended from the first, second, third and fourth sidewalls 410, 420, 430 and 440. In alternative embodiments, the second protrusions 460 may extend from less than all of the first, second third and fourth sidewalls 410, 420, 430 and 440, such as from one of the first, second third and fourth sidewalls 410, 420, 430 and 440. The second protrusions 460 may be apart from each other at substantially uniform intervals or be spaced apart at any of a number of intervals as it suitable for the purpose described herein. The liquid crystal display panel 110 is positioned between the second protrusions 460. The liquid crystal display panel 110 may be essentially fixed by the second protrusions 460. The first protrusion 450 may efficiently support the liquid crystal display panel 110 thereon.

In exemplary embodiments, the second protrusion 460 may include a burr-receiving portion 490 as illustrated in FIGS. 4 and 5. The burr-receiving portion 490 may correspond to the pinpoint gate of the metal mold. The burr-receiving portion 490 may also be a recess.

A depth “a” of the recess may be substantially larger than a height of a burr 491. In an exemplary embodiment, the depth of the recess may be in a range of about 0.5 mm to about 1.0 mm.

As illustrated in FIG. 4, the burr-receiving portion 490 has a substantially circle shape. In alternative embodiments, a shape of the burr-receiving portion 490 may vary in accordance with a shape of the pinpoint gate of a bush (not shown). For example, in case that the pinpoint gate of the bush has a rectangular shape, the burr-receiving portion 490 may have a substantially rectangular shape.

As illustrated in FIGS. 4 and 5, the burr-receiving portion 490 may be the recess having the depth “a” substantially larger than the height of the burr 491. Thus, the burr 491 may minimally or not protrude from the burr-receiving portion 490.

In other exemplary embodiments, where the source and the gate flexible circuit films 140 and 150 are bent such that the source and gate drive circuit board 120 and 130 may make contact with a rear face of the first receiving container 300, the source and gate flexible circuit films 140 and 150 may be disposed between the second protrusions 460. Advantageously, the source and gate flexible circuit films 140 and 150 may be minimally damaged by the burr 491 received in the burr-receiving portion 490.

In addition, because the burr 491 is received in the burr-receiving portion 490 of the second protrusion 460, the second receiving container 400 may be easily combined with other parts of the liquid crystal display device 10.

Referring to FIG. 3, the second receiving container 400 has combination recesses 470 downwardly extended from the first, second, third and fourth sidewalls 410, 420, 430 and 440. The combination recesses 470 are combined with combination protrusions 310 of the first receiving container 300 illustrated in FIG. 1 such that the second receiving container 400 may be combined or essentially joined with the first receiving container 300. The second protrusions 460 may be upwardly extended from the first, second, third and fourth sidewalls 410, 420, 430 and 440. The liquid crystal display panel 110 is positioned between the second protrusions 460. That is, the liquid crystal display panel 110 is fixed by the second protrusions 460. Thus, the first protrusion 450 may efficiently support the liquid crystal display panel 110 thereon.

In addition, the second receiving container 400 may include third protrusions 480. The third protrusions 480 may guide the liquid crystal display panel 110 to be stably received into the second receiving container 400. The third protrusions 480 may be upwardly protruded from the first, second, third and fourth sidewalls 410, 420, 430 and 440. The third protrusions 480 are illustrated in FIG. 3 at corners where the first, second, third and fourth sidewalls 410, 420, 430 and 440 respectively meet each other and spaced along the first, second, third and fourth sidewalls 410, 420, 430 and 440. In alternative embodiments, there may be any of a number of the third protrusions 480 of a variety of sizes disposed at varying intervals along the first, second, third and fourth sidewalls 410, 420, 430 and 440 as is suitable for the purpose described herein.

In an exemplary embodiment of the forming of the second receiving container 400, a bush having a pinpoint gate corresponding to the third protrusion 480 may be combined with the metal mold such that the molding quality of the second receiving container 400 may be improved. Where the metal mold includes the pinpoint gate corresponding to the third protrusion 480, the third protrusion 480 may also have the burr-receiving portion 490.

Referring again to FIG. 1, the first receiving container 300 receives the third receiving container 250 in which the reflection plate 230, the light guide panel 220, the lamp 210 and the optical sheets 240 are sequentially received. The first receiving container 300 may have a window (not shown) at a central portion thereof. Advantageously, heat generated from the lamp unit 210 may be exhausted through the window.

The top chassis 500 is positioned over the second receiving container 400 and the liquid crystal display panel 110. The top chassis 500 has a window at a central portion thereof such that the top chassis 500 may selectively cover an edge portion of the liquid crystal display panel 110 therewith.

The backlight assembly 200 as illustrated in FIG. 1. is an edge-typed backlight assembly 200 including the lamp unit 210 combined with a sidewall of the light guide panel 220. In alternative embodiments, two lamp units 210 opposite to each other may be combined with sidewalls of the light guide panel 220, the sidewalls also being opposite to each other.

However, many apparent variations of the backlight assembly 200 may be used without departing from the spirit or scope of the present invention. In one exemplary embodiment, the backlight assembly 200 may include a light guide panel 220 having a wedge shape. That is, the light guide panel 220 becomes substantially thinner in a direction away from a first face facing a light source toward a second face opposite to the first face. In another exemplary embodiment, the backlight assembly 200 may be a direct illumination-type backlight assembly 200 where a lamp is positioned under the liquid crystal display panel 110.

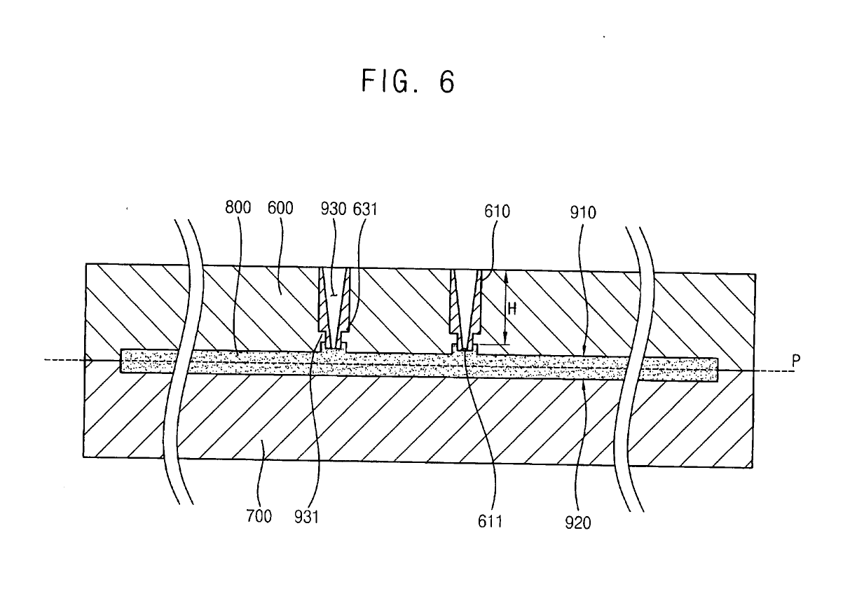

FIG. 6 is a partial cross-sectional view illustrating an exemplary embodiment of a metal mold used for an injection molding process in accordance with the present invention.

An exemplary embodiment of a method for forming the second receiving container 400 having the burr-receiving portion 490 illustrated in FIGS. 3 to 5 will now be described with reference to FIG. 6.

In order to manufacture the second receiving container 400, a shape of the second receiving container 400 is designed. An upper core 600 and a lower core 700 forming the metal mold in which the second receiving container 400 is to be formed are manufactured. The bush 610 having the pinpoint gate 611 through which the melted resin is to be injected into the metal mold is manufactured. The bush 610 is combined with the upper core 600. The melted resin is injected into the metal mold through a pinpoint gate 611 of the bush 610.

The first, second, third and fourth sidewalls 410, 420, 430 and 440, the first protrusion 450 and the second protrusions 460 may determine the shape of the second receiving container 400. The first, second, third and fourth sidewalls 410, 420, 430 and 440 are connected to each other. The first protrusion 450 is inwardly protruded from inner faces of the first, second, third and fourth sidewalls 410, 420, 430 and 440 such that the liquid crystal display panel 110 may be positioned on the first protrusion 450. That is, the first protrusion 450 supports the liquid crystal display panel 110 thereon. The second protrusions 460 are upwardly protruded from the first protrusion 450. The second protrusions 460 may be apart from each other at the substantially uniform intervals. The second protrusion 460 has the burr-receiving portion 490 into which the burr 491 due to the residual of the melted resin is received. The burr 491 may be minimally protruded from the burr-receiving portion 490. The liquid crystal display panel 110 is positioned between the second protrusions 460. That is, the liquid crystal display panel 110 is fixed by the second protrusions 460. Thus, the first protrusion 450 may efficiently support the liquid crystal display panel 110 thereon.

The upper core 600 has a first molding recess 910 at a lower face portion thereof. The first molding recess 910 is recessed from a datum plane P toward a body of the upper core 600. The upper core 600 and the lower core 700 contact each other on the datum plane P. A shape of the first molding recess 910 corresponds to a shape of an upper portion of the second receiving container 400.

Openings 930 are formed through the upper core 600 between portions of the bush 610. Each of the openings 930 corresponds to each of the second protrusions 460. A protrusion 931 protrudes at a lower portion of an inner face of the opening 930. Thus, a diameter of an upper portion of the opening 930 may be substantially larger than that of the lower portion of the opening 930.

The lower core 700 has a second molding recess 920. The second molding recess 920 is recessed from the datum plane P toward a body of the lower core 700. The shape of the lower core 700 corresponds to a shape of a lower portion of the second receiving container 400.

The upper core 600 and the lower core 700 are combined with each other such that a metal mold having a cavity 800 therein is formed. The first molding recess 910 and the second molding recess 920 together define the cavity 800. The cavity 800 has a shape substantially similar or corresponding to the second receiving container 400. The bush 610 having the pinpoint gate 611 is inserted into the opening 930. A height of the bush 610 may be substantially larger than a height (H) of the opening 930. That is, the bush 610 may be substantially longer than the opening 930. A portion of the bush 610 may be downwardly protruded from an upper face of the first molding recess 910. In other words, the downwardly protruded portion of the bush 610 may be downwardly protruded from the protrusion 931. A height of the downwardly portion of the bush 610 may be from about 0.5 mm to about 1 mm.

The burr-receiving portion 490 of the second protrusion 460 corresponds to the portion of the bush 610, the portion being downwardly protruded from the upper face of the first molding recess 910. Thus, the depth of the burr-receiving portion 490 is substantially similar and corresponds to the height of the portion of the bush 610.

The bush 610 has a stepped portion 631. The stepped portion 631 may be combined with the protrusion 931. The bush 610 may be fixed firmly in the opening 930 and maintain its position against an injection pressure applied thereto. In addition, although the injection pressure may increase against the height of the portion of the bush 610 where the portion is downwardly protruded, an upper face of the first molding recess 910 may be uniformly maintained.

The melted resin is injected from the pinpoint gate 611 into the cavity 800. After the melted resin in the cavity 800 is fully cooled, the upper core 600 and the lower core 700 are separated from each other. Thus, the second receiving container 400 is formed.

When the upper core 600 and the lower core 700 are separated from each other, the burr 491 due to the residual of the melted resin is formed on a bottom face of the burr-receiving portion 490. Thus, the burr 491 may minimally protrude from the burr-receiving portion 490.

According to an illustrated exemplary embodiment, a burr may minimally protrude from a burr-receiving portion. Advantageously, a second receiving container having the burr-receiving portion in which the burr is received may be easily combined with other parts of a liquid crystal display panel. In addition, the burr may cause minimal or no damage to a source flexible circuit board or a gate flexible circuit board such that a display quality and a yield may be improved. Furthermore, in case that a pinpoint gate is deteriorated by a melted resin having a relatively high temperature, a bush having the pinpoint gate may be selectively replaced. Thus, it is advantageous in cost saving to selectively replace the bush rather than to fully replace a metal mold.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A receiving container comprising:
a plurality of sidewalls connected to each other;
a first protrusion inwardly extending from inner side faces of the sidewalls, wherein a display panel is positioned on the first protrusion; and
a plurality of second protrusions upwardly extending from at least one of the sidewalls, the second protrusions fixing the display panel and including a burr-receiving portion configured for receiving a burr generated due to a residual of a melted resin.

2. The receiving container of claim 1, wherein the second protrusions are spaced apart from each other.

3. The receiving container of claim 1, wherein the burr-receiving portion is configured as a recess.

4. The receiving container of claim 3, wherein a depth of the recess is about 0.5 mm to about 1.0 mm.

5. The receiving container of claim 1, wherein the burr-receiving portion is configured such that the burr does not protrude from the burr-receiving portion.

6. The receiving container of claim 1, further comprising a third protrusion protruding upward from at least one of the sidewalls and configured to stabilize the display panel in the receiving container.

7. The receiving container of claim 6, wherein the third protrusion includes the burr-receiving portion.

8. A method for manufacturing a receiving container, the method comprising:
designing a shape of the receiving container including sidewalls, a first protrusion and second protrusions, the sidewalls connected with each other, the first protrusion inwardly protruded from inner faces of the sidewalls, a display panel positioned on the first protrusion, the second protrusions upwardly extending from at least one of the sidewalls, the second protrusions fixing the display panel, the second protrusion including a burr-receiving portion configured to receive a burr;
providing an upper core including a first molding recess at a lower face portion of the upper core, a shape of the first molding recess corresponding to a shape of an upper portion of the receiving container and openings communicated with the first molding recess, the openings corresponding to the second protrusions;
providing a lower core including a second molding recess at an upper face portion of the lower core, a shape of the second molding recess corresponding to a shape of a lower portion of the receiving container;
providing a bush including a height substantially larger than a height of the opening and a pinpoint gate through which a melted resin is injected;
disposing the bush into the opening; and
injecting the melted resin between the upper core and the lower core by the pinpoint gate.

9. The method of claim 8, wherein the receiving container further comprises a third protrusion configured to stabilize the display panel in the receiving container, wherein the pinpoint gate corresponds to the third protrusion.

10. The method of claim 8, wherein the bush further includes a portion downwardly protruded from an upper face of the first molding recess.

11. The method of claim 10, wherein the portion includes a height of about 0.5 mm to about 1.0 mm.

12. A backlight assembly comprising:
a lamp generating a light;
a first receiving container receiving the lamp; and
a second receiving container received into the first receiving container, the second receiving container including:
a plurality of sidewalls connected to each other,
a first protrusion inwardly extending from inner faces of the sidewalls, and
a plurality of second protrusions upwardly extending from at least one of the sidewalls and including a burr-receiving portion receiving a burr, and
a display panel positioned on the first protrusion, the display panel being fixed by the second protrusions.

13. The backlight assembly of claim 12, wherein the burr-receiving portion is a recess.

14. The backlight assembly of claim 12, wherein the lamp is proximate to a lower portion of the display panel.

15. The backlight assembly of claim 12, wherein the lamp is proximate to a side portion of the display panel.

16. The backlight assembly of claim 12, further comprising a light guide panel configured to guide a path of a light incident thereon from the lamp and irradiate the light toward the display panel.

17. Adisplay device comprising:
a backlight assembly including:
a lamp generating a light,
a first receiving container receiving the lamp, and
a second receiving container, received into the first receiving container, the second receiving container including a plurality of sidewalls, a first protrusion and a plurality of second protrusions, the sidewalls connected to each other, the first protrusion inwardly extending from inner faces of the sidewalls, and the second protrusions upwardly extending from at least one of the sidewalls and including a burr-receiving portion receiving a burr, and
a display panel positioned on the first protrusion, the display panel being fixed by the second protrusions
a plurality of optical sheets through which the light generated from the lamp passes; and
a display unit displaying images by using the light passing through the optical sheets.

18. The display device of claim 17, further comprising a fixing member combined with the first receiving container to fix the display unit.

19. The display device of claim 17, wherein the display unit comprises;
the display panel;
a printed circuit board providing the display panel with a drive signal; and
a flexible circuit film being connected between the printed circuit board and the display panel to provide the drive signal to the display panel.

20. The display device of claim 19, wherein the flexible circuit film is bent between the second protrusions.

21. The display device of claim 19, wherein the flexible circuit film includes a drive chip, is a tape carrier package, is a chip on film, or any combination including at least one of the foregoing.

22. The display device of claim 19, wherein the printed circuit board makes contact with a rear face of the first receiving container.

23. The display device of claim 17, wherein the display panel is a liquid crystal display panel including a first substrate, a second substrate and a liquid crystal layer that is positioned between the first substrate and the second substrate.

24. The display device of claim 17, further comprising a third receiving container configured to receive the backlight assembly.

25. The display device of claim 24, wherein the second receiving container further comprises combination members downwardly extended from at least one of the sidewalls and the third receiving container comprises combination protrusions, wherein the combination members and the combination protrusions are configured to allow the second receiving container to be fixed to the third receiving container.
